(19) United States
(12) Patent Application Publication
(10) Pub. No.: US 2022/0036407 A1
(43) Pub. Date: Feb. 3, 2022

(54) METHODS AND SYSTEMS TO INCREASE USER ENGAGEMENT WITH ADVERTISEMENTS

(71) Applicant: Sarangan Narasimhan, Sunnyvale, CA (US)

(72) Inventor: Sarangan Narasimhan, Sunnyvale, CA (US)

(21) Appl. No.: 16/945,915

(22) Filed: Aug. 2, 2020

(51) Int. Cl. G06Q 30/02

(52) U.S. Cl. CPC G06Q 30/0277; G06Q 30/0246

(57) ABSTRACT

A method for increasing user engagement with advertising, for a user consuming streamed user-selected content, includes: selecting a sequence of previously produced advertisements, beginning with a first advertisement followed by a second advertisement, for the user; generating a first challenge relating to each advertisement, the generation occurring subsequent to and independent of the production of that advertisement. At a break in streaming the selected content to a device through which the user is experiencing the user-selected content, the first advertisement is streamed to the device; and the corresponding first challenge is presented to the user on the device. The method responds to a correct answer provided by the user, within a first set time interval, to the first challenge by terminating the break and resuming streaming of the user-selected content to the device.

### FIELD OF THE INVENTION

The present invention relates to increasing user engagement with advertisements presented to a user in breaks during the streaming of content. More specifically, embodiments of the invention relate to methods and systems for rewarding the user for demonstrably paying attention to advertisements.

### BACKGROUND OF THE INVENTION

Media services that are in part financially supported by presenting advertisements during commercial breaks have a clear interest in capturing the user's attention during those breaks, to be able to assure the advertisers that their material is actually watched, and that their content is absorbed. However, research shows that advertisements displayed during interruptions in the presentation of desired content currently suffer from poor engagement, with many users resenting the interruption and/or taking advantage of the break to check their phones, run to the kitchen to get a snack, etc. It has been credibly reported, for example, that only about 45% of TV viewers actually watch the advertisements.

At this time, media consumers are ‘cutting the cord’ at a steady pace, switching from cable to video streaming services, with many streaming companies enjoying robust market growth. However, the potential profitability of streaming services is severely capped by consumers' willingness to pay subscription fees, and it is envisaged that price pressure on subscription fees will simply increase with competition. Revenues from advertisements are attractive, and an advertising-based model rather than a subscription-based one may be the most viable financial option for streaming services in the near future.

Some reward-based incentives to increase user engagement with streamed advertisements have been proposed. They include such approaches as offering the user “points” exchangeable for purchases, or a chance to be included in a random drawing for some sort of prize. In each case, the reward is usually given in response to the user answering questions set by the producer of the advertisements. However, none of these approaches seem to address the basic issue from the user's point of view, which is that a user who has chosen to experience a particular piece of content is inclined to resent interruptions of that content, and will want those interruptions to be as short and painless as possible.

There is therefore a need to boost the value of streamed advertisements by increasing user engagement with those advertisements, using a method or system that provides the advertiser tangible assurance of that engagement while minimizing the interruption of desired content streaming experienced by the user. Ideally, the user would be able to quickly demonstrate some significant absorption of features of the advertising material of value to the advertiser.

### SUMMARY OF THE INVENTION

The present invention includes devices and methods for increasing user engagement with advertising, for a user consuming streamed user-selected content that includes such advertising during commercial breaks. The term “user-selected” is defined herein as including content that is indirectly selected, such as content that is streamed automatically when a web-page is opened by the user, the key feature being that it is content that is to some degree deliberately chosen by or “pulled” by the user, as opposed to content that is “pushed” into the user's experience or consciousness by another party. “User-selected” further includes content that the user has had a minor role in selecting—for example, clicking on a cable TV channel in a TV guide and viewing the content on that channel involves a role in “selecting”, even if the precise content shown by the channel happens to be determined by the channel provider and not the user. The user still exhibited a preference and “selected” the exact channel they were going to watch. Similarly launching a website or streaming channel that automatically starts streaming recommendations to the user is included in the definition of “user-selected.” Even though the content provider chose the specific content to the stream, the user still played a role in “selecting” by launching the website or streaming channel, or other related content provided service.

In one embodiment, the method comprises: selecting a sequence of previously produced advertisements, beginning with a first advertisement followed by a second advertisement, for the user; for each of the advertisements, generating a first challenge relating to that advertisement, the generation occurring subsequent to and independent of the production of that advertisement; and at a break in streaming the selected content to a device through which the user is experiencing the user-selected content: streaming the first advertisement to the device; after the first advertisement ends, presenting the corresponding first challenge to the user on the device; and responding to a correct answer provided by the user, within a first set time interval, to the first challenge by terminating the break and resuming streaming of the user-selected content to the device.

In another embodiment, an apparatus comprises: one or more processors; and logic encoded in one or more non-transitory media for execution by the one or more processors, the logic, when executed operable to: select a sequence of previously produced advertisements, beginning with a first advertisement followed by a second advertisement, for the user; for each of the advertisements, generate a first challenge relating to that advertisement, the generation occurring subsequent to and independent of the production of that advertisement; and at a break in streaming the selected content to a device through which the user is experiencing the user-selected content: stream the first advertisement to the device; after the first advertisement ends, present the corresponding first challenge to the user on the device; and respond to a correct answer provided by the user, within a first set time interval, to the first challenge by terminating the break and resuming streaming of the user-selected content to the device.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a process flow diagram of a method according to some embodiments of the present invention.

FIG. 2 illustrates a display with a challenge posed to a user, regarding an advertisement that has just been viewed, according to some embodiment of the present invention.

FIG. 3 illustrates a display with a challenge posed to a user, regarding an advertisement that has just been viewed, according to some other embodiments of the present invention.

FIG. 4 illustrates a display with a challenge posed to a user, regarding an advertisement that has just been viewed, according to yet other embodiments of the present invention.

FIG. 5 illustrates a display with a challenge posed to a user, regarding an advertisement that has just been viewed, according to a different set of embodiments.

FIG. 6 illustrates a display with a challenge posed to a user, regarding an advertisement that has just been viewed, according to another different set of embodiments.

FIG. 7 illustrates a display with a challenge posed to a user, regarding an advertisement that has just been viewed, according to another different set of embodiments.

FIG. 8 illustrates a display through which a user is queried to solicit brand feedback related to an advertisement that has just been viewed, according to some embodiments.

### DETAILED DESCRIPTION

Embodiments described herein increase user engagement with advertising that is streamed to the user during breaks in the presentation of content that the user has selected.

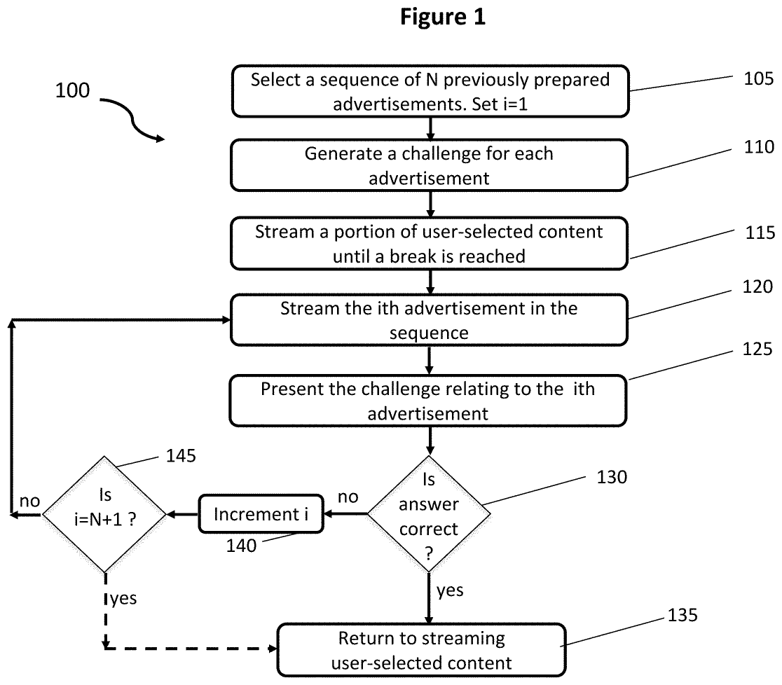

FIG. 1 is a flowchart of a method 100 according to some embodiments of the present invention. At step 105, a sequence of N already prepared advertisements is selected, where N is an integer greater than or equal to 2. In some cases, the selection may be based in part on known characteristics of the user such as age, gender, areas of interest, history of choices of streamed content, etc. It should be understood that “selecting a sequence” may comprise either selecting the number and specific advertisement to show to the user, or as an alternative selecting, N, the number of advertisements to show to the user with the specific advertisement to show to come at some point in time prior to the beginning of the streaming of the individual advertisement itself. Subsequent advertisements may thus be selected as late as the moment they themselves begin streaming to the user. So for example the second advertisement may only be chosen after the challenge for the first advertisement has been completed and the second advertisement is about to begin streaming.

At step 110, a challenge is generated relating to each advertisement. At step 115, user-selected content is streamed to the user until a break is reached, typically after a particular interval of time has elapsed, or at some other convenient point in the streamed content. In some embodiments, not shown, the order in which steps 110 and 115 are performed may be reversed, or these steps may overlap in time. At step 120, considering the first pass through the iterative loop to be described below, the first advertisement in the sequence is streamed to the user, and at step 125, the corresponding challenge is presented for the user to answer. At step 130, the user's answer is evaluated. A correct answer leads to step 135, which terminates the break and resumes streaming the user-selected content. An incorrect answer leads to steps 140 and 145 which result (again considering the first pass through the loop for simplicity) in the method flow looping back to step 120, at which point the second advertisement in the sequence is streamed to the user, followed by step 125 for the next challenge, relating to the second advertisement, and so on. If and when the last advertisement in the sequence has been streamed, even if the answer provided by the user is incorrect, the break is terminated and streaming of the user-selected content is resumed.

In some embodiments, not shown, an alternative path may be followed after an incorrect answer is received instead of proceeding directly from step 130 to 140 and 145. In these embodiments, an alternative challenge (which would have been generated in a modified version of step 110) is presented to the user, offering them a second chance to avoid having to watch another advertisement before getting back to the desired content. The alternative challenge may be in some sense easier than the original challenge, or may focus on a different aspect or portion of the advertisement, for example.

As the flowchart shows, challenges are generated after the advertisements themselves are produced. The time gap may, for example, allow the challenges to be tailored to a specific user or type of user as late as the time that the user streams the advertisement. However, the time gap between the production and the challenge generation does not have to be that long. In some cases, the generation may occur immediately following the creation of the advertisement, and may well involve the preparation of a batch of challenges that are tailored to various “macro-level” user profiles. This could speed the deployment of the present invention, making different challenges readily available, from which a particular challenge may be selected closer to the time a particular user begins the streaming. The term “subsequent to” recited in the claims should be understood as including the full range of time gaps, from immediately following the production of the advertisement, up to the end of streaming of the specific advertisement being shown. In this scenario, technologies such as AI (artificial intelligence) can be used to generate challenges in minimal time as late as during the streaming of the advertisement to the user or even at the conclusion of the advertisement itself.

It is further understood that when creating challenges for advertisements in step 110, challenges may be generated for a first advertisement in a sequence, while challenges for subsequent advertisements are generated at a later moment in time as late as at the conclusion of the streaming to the user of the subsequent advertisement itself. In other words challenges for each advertisement can be generated independent of each other as it is not necessary for the challenges to be generated together in batches for multiple advertisements.

While the most common method of presenting advertisements to a user is to split the desired content into sections separated by short breaks, each break filled by a batch of advertisements, another option that is sometimes used is to show a batch of advertisements just prior to streaming the desired content. The ideas discussed herein, focused on rewarding a correct answer by immediately returning to streaming the next section of desired content, can still be applied in this scenario, by rewarding a correct answer by immediately starting the streaming of the content, from the beginning of that content. The present invention should therefore be understood as encompassing scenarios where the advertisements are presented before the streaming of the content begins, as well as those where they are interspersed during the ongoing streaming.

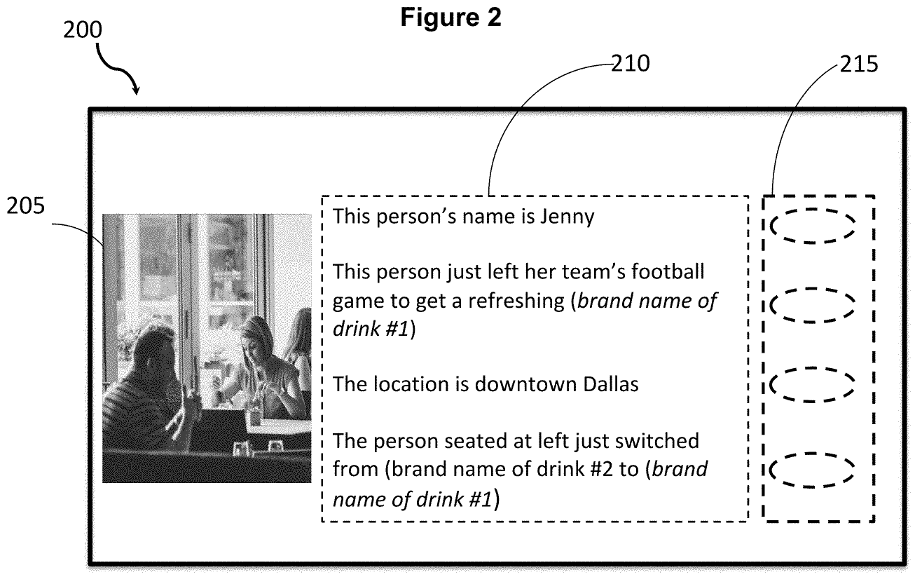

FIG. 2 illustrates a display screen 200 viewed by the user in some embodiments of the present invention. Examples of display screen 200 may include the screen of a TV or a computer or a smartphone. In the illustrated example, a frame or part of a frame 205 from the advertisement that has just been seen by the user is shown on the left, and the user is asked at 210 to consider a set of statements about the advertisement, and select at 215 which if any the user thinks is true. Typically, one of the statements will be true and the rest are false, but in other cases there may be more than one true statement, or there may be no true statements. FIG. 2 shows a case where the selection is made by checking a box next to the chosen statement, but other options may readily be envisaged, such as clicking directly on the chosen statement to highlight it, etc.

The goal of these embodiments is to encourage the user to pay attention to the narrative of the advertisement, which may be obviously related to the “message” of the advertisement (e.g. brand A is far superior to brand B because of X) or may be an incidental detail, like the name of a person, the location of some event or occurrence, or an action that occurs. They depend on the fact that the advertisement is telling a story, and the challenge is to show recall of some factual content that is taught by or present within the story.

In some cases, there may be significant advantages in using some type of Artificial Intelligence (AI) technology to generate the set of statements that make up challenge 210. This would typically involve the use of a neural network, trained to scan the advertisement and understand its meaning. Examples of such networks include ASR (uses Automatic Speech Recognition to convert speech in a video stream to text), BERT (uses Natural Language Processing on speech in a video stream), SSD (uses Single Shot Detection or Object Detection to detect objects in the video stream), ResNet-50 (carries out Image Classification in the video stream), and DLRM (a Deep Learning Recommender). Combinations of these can be used to provide challenge statement recommendations based on the content of the advertisements, and this can be done quite independently of the producers of those advertisements. The generation process can be carried out quickly and efficiently, and may even occur in real time during the presentation of the advertisements, rather than well in advance, opening the possibility of “fine tuning” the set of statements based on the individual user's profile. This could dramatically boost engagement, further increasing the value to advertisers.

In other words, AI could enable the posing of customized/tailored challenges automatically at scale to all users, working from the same “pool” of previously prepared, typically high cost, advertisements. Although this has been described with reference to the particular narrative-based challenges of the type of embodiments shown in FIG. 2, AI could be used for generating challenges for any of the embodiments described below.

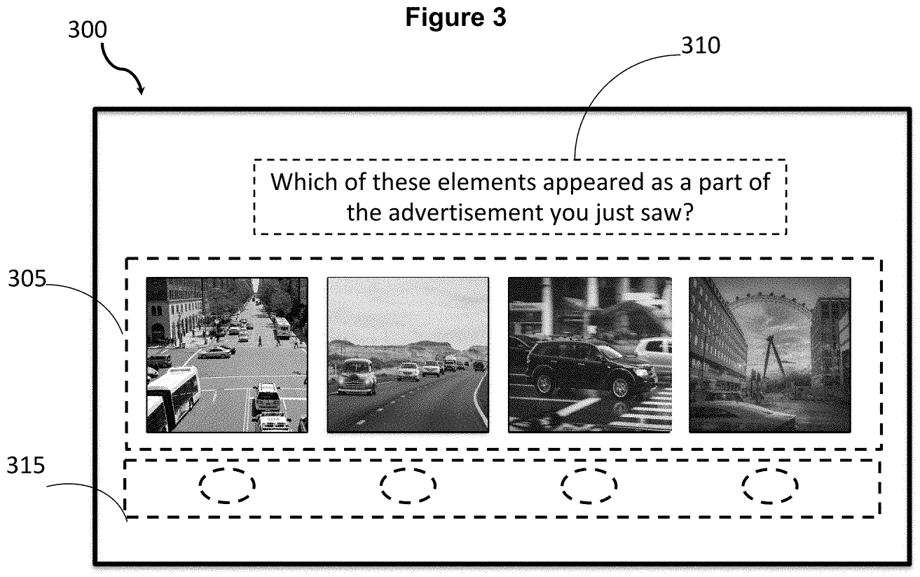

FIG. 3 illustrates a display screen 300 viewed by the user in some other embodiments of the present invention. In these embodiments, a set of elements 305 is presented to the user, these elements being (in the video applications considered for simplicity throughout most of this disclosure) images, either of complete scenes or frames, or parts of them. In the embodiment shown, one of the elements presented would have actually been included in the advertisement as it was originally produced, and would therefore have been perceptible to the user when it was streamed, while other elements in the set were not included in that advertisement. The challenge 310 posed to the user is essentially a request to select the perceptible element that was included in the advertisement. The user can make their selection in the corresponding check boxes 315.

In some embodiments, more than one of the elements 305 presented may have been included in the advertisement, and the corresponding challenge would be considered to have been correctly responded to if any one of those elements that had appeared in the advertisement were selected by the user.

A different image may be the correct choice each time the query is made to a particular user, using different scenes or subsets of this commercial. This helps minimize the chances of the viewer ‘learning’ the correct answer and not paying attention to the advertisement in subsequent viewings. In some cases, it may be helpful to use a part of the advertisement for the correct query image that is in the background or in a seemingly less significant part of the advertisement. This may ensure complete engagement by the viewer, as they have to pay attention to all the details to answer the question correctly.

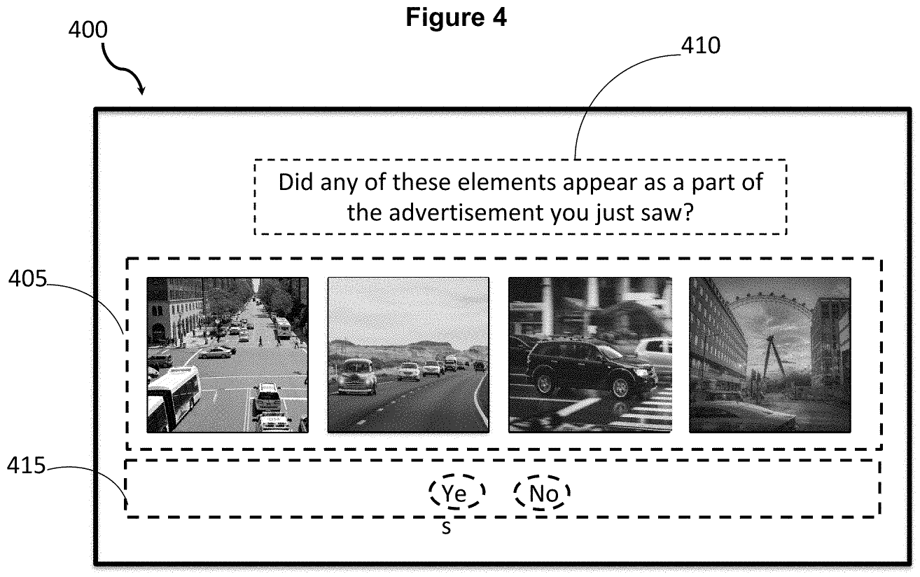

FIG. 4 illustrates a display screen 400 viewed by the user in embodiments similar to that of FIG. 3, but in this case allowing for the option where none of the elements that were present in the advertisement are shown to the user, by offering the user (in challenge 410) the option of answering Yes or No at 410 regarding the series of elements 405. The challenge is presented in display 400 in the form of a direct question with a simple yes/no answer, but other options may easily be envisaged, such as a statement, with a true/false response expected.

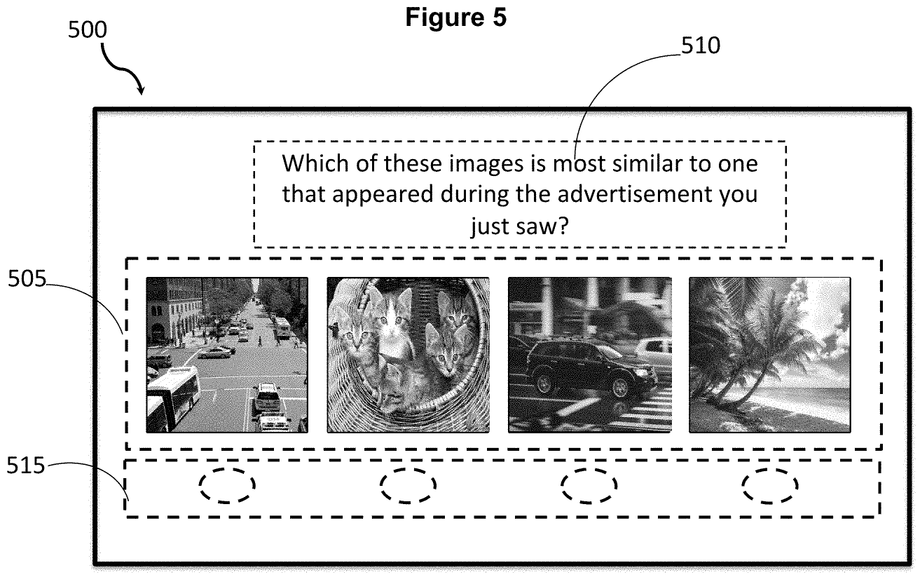

FIG. 5 illustrates a display screen 500 viewed by the user in some other embodiments of the present invention. In these embodiments, a set of images 505 is shown to the user, none of which were actually present in the advertisement just streamed to the user. However, one of those images (which as in the embodiments described above with respect to FIGS. 3 and 4 could either be a complete scene or frame, or a part of a one) is more similar in some significant sense to an image that was actually present in the advertisement than are any of the other images in set 505. If, for example, the advertisement showed a sequence of frames in which a key moment is when a basket of cute puppies is delivered to the main actor, the images shown to the user might include one image of a basket containing cute kittens, while the other images show a variety of other objects that were not present in any part of the advertisement, or were similar to objects that were present in a minor background role. The challenge 510 posed to the user is essentially a request to select the image that is the most similar. The user can make their selection in the corresponding check boxes 515.

The main benefit to the advertiser of the method used by FIG. 5 embodiments is that it avoids the user ‘learning the ad’ and the answers over time and not paying attention to it in subsequent viewings. They still need to engage with the advertisement each time they see it, to make sure they are choosing the ‘most similar’ answer. In some cases, AI image algorithms may be a useful way to generate the scenes to be shown, as the correct answer is no longer an exact scene from the advertisement. This creates more possible combinations for the advertiser to show, to ensure a different answer by a given user each time they see the advertisement.

In the embodiments discussed above, the advertisements are streamed to the user essentially in the form they were produced, prior to being selected for the user engagement enhancement purposes of the present invention.

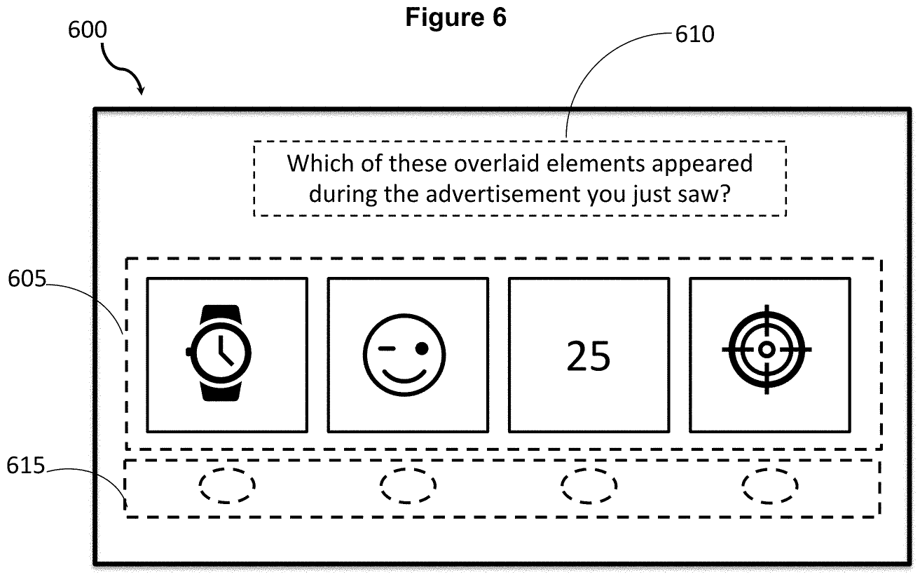

FIG. 6 illustrates a display screen 600 viewed by the user in some other embodiments of the present invention. In these embodiments, one or more perceptible elements (graphical images of symbols or characters in the video applications considered for simplicity throughout most of this disclosure, as previously noted) are overlaid onto one or more frames of the advertisement at any time after the advertisement was produced. The perceptible elements or overlay may even be added to the advertisement as late as during the time the advertisement is streamed to the user when the perceptible elements or overlay may appear in real time in the advertisement video stream. Examples of images suitable for this purpose include numerals, letters, icons, emojis, and emoticons. They may in some cases be tailored to the user's profile or characteristic data on file. They can appear anywhere on screen at random times throughout the advertisement (to ensure the whole advertisement is watched), They may be viewed as distracting, but they can also be partial overlays of a semi-transparent nature to minimize obstruction of the advertisement itself.

After the advertisement is shown, a set of images 605 is presented to the user, at least one of the images being a symbol or character that was actually present (as an overlaid image) in the advertisement just streamed to the user, while the other one or more images were not present in that advertisement. The challenge 610 posed to the user is essentially a request to select the overlaid image that was present. The user can make their selection in the corresponding check boxes 615. FIG. 6 is analogous to FIG. 3, but in this case the correct image in the set under consideration has been added to the advertisement rather than intrinsically being a part of the advertisement as it was originally produced.

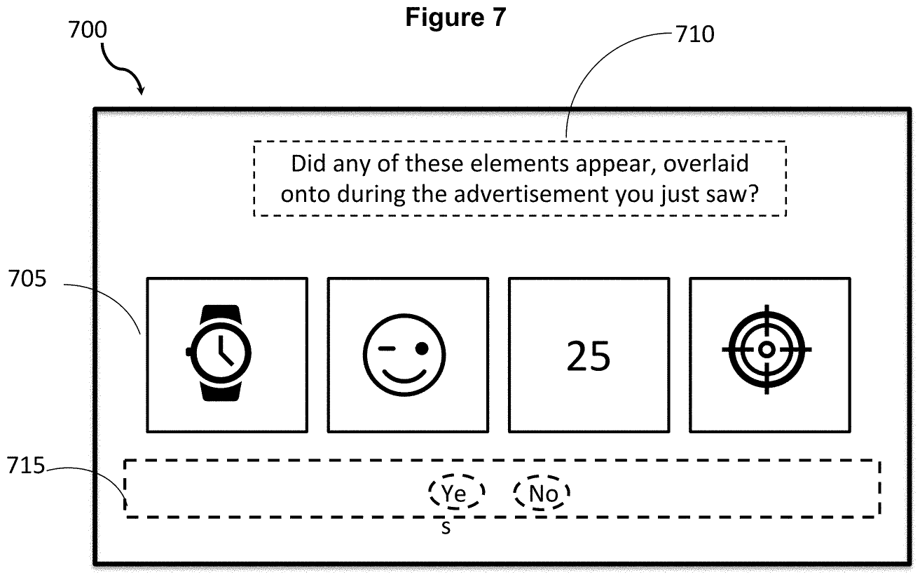

FIG. 7 illustrates a display screen 700 for other embodiments similar to those illustrated in FIG. 6, where one or more elements, typically graphical images of symbols or characters, are overlaid onto one or more frames of the advertisement before or during the time it is presented to the user, but in these cases the set of elements 705 subsequently shown to the user may or may not include any element overlaid onto the advertisement, and the challenge 710 posed to the user is to confirm or deny at 715 that any of the shown images had been perceived in the advertisement. As in the embodiments discussed above with respect to the analogous FIG. 4 embodiments, the challenge may be presented in the form of a direct question with a simple yes/no answer as shown, but other options may easily be envisaged, such as a statement with a true/false response expected.

In some cases, characteristics of the user may be taken into account in selecting the advertisements to be seen (as noted previously), but also or alternatively in selecting the order in which those advertisements are arranged in presentation sequence, and/or in generating the particular challenges posed to that user. This “individual” tailoring may be a valuable feature.

In all the embodiments discussed above, words such as “image”, “scene” and “shown” should not be taken as limiting the invention to visual media, literally seen on a display screen by the user, whether said content comprises dynamic visual media like video, or more statically oriented visual media like a webpage or mobile app. The same inventive ideas disclosed herein may be applied to audio systems, where the advertisements are streamed during breaks in a podcast, for example, or an audiobook, or a recorded concert. The terms “perceptible” and “perceived” should similarly be understood to encompass the sense of hearing as well as, or instead of, sight. The term “element” should be understood as often but not always being equivalent to “image”; it could for example be a sound. However, for simplicity, the figures accompanying this written description of course imply that the elements are images.

Embodiments described herein provide various benefits in systems and methods for increasing user engagement with one type of content that interrupts or is otherwise added to a second type of content selected by a consumer.

While the ideas described above are expected to be targeted in the first instance toward gauging and ultimately improving engagement in advertisements shown in breaks during the streaming of TV content, the same type of technology platform can be used anywhere there are multimedia video (or purely audio) streams and one wants to gauge engagement with interspersed information in the form of video (or audio) clips, which need not be advertising as such, but could be public service announcement (PSA) videos, or indeed any other stream-able content in which engagement may be considered desirable. It may also be used in connection with advertising, announcements, or similar promotions on websites, social media feeds, news feeds, mobile apps and other forms of digital content, where the advertisement, announcement or promotion may briefly overlay, obscure, or limit access to the content the user is trying to browse.

In an audio example where songs are being streamed to a user without a subscription fee, the content provider may need to provide audio advertisements to monetize their content. An implementation can be envisaged where a user listens to a few songs for free, and then hears an ad and has to provide the correct challenge response using the present invention on the advertisement to return to the stream of songs.

Currently various types of streamed content are difficult to monetize and advertisements on these platforms suffer from weak engagement by users. This problem exists for digital content on TV, mobile, desktop, IoT (Internet of Things) as well as other digital devices where the user has a mechanism to provide feedback on the content. The content providers frequently embed many advertisements across limited display real-estate in a desperate attempt to ensure that the user will at least engage with (or ‘click on’ or ‘hover their cursor over’) one of the advertisements. Alternative attempts to monetize content involve subscription fees, website or mobile app paywalls, and other accounts based payment mechanisms like using rewards points, many of which suffer from an enrollment or registration problem where most users do not want to register and provide a payment method such as a credit card.

The present invention offers a more productive alternative. Content providers can present one, or a limited number of advertisements, announcements or promotions, that obscure some or all of the digital content. Users would have to engage with the advertisement and provide a correct response for obscured content to be made available. Since engaged advertisements provide high monetization, the content provider is assured of a dependable revenue source for the service that they provide. This eliminates the need for some of the cumbersome monetization options that currently exist for content providers, such as a clutter of advertisements occupying a lot of the screen but receiving low engagement, subscription fees, website paywalls and so on.

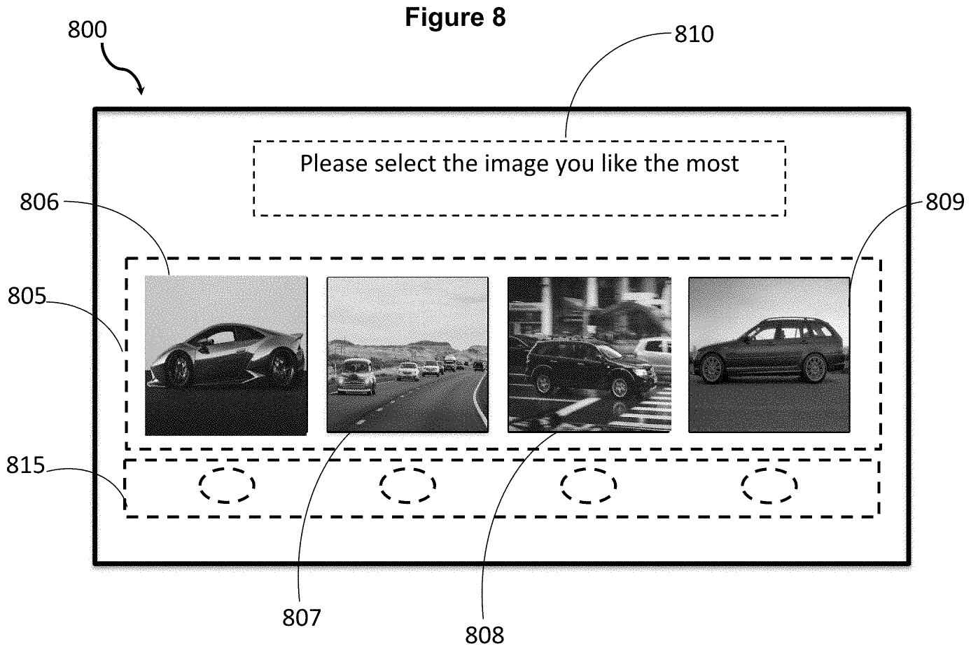

In an alternative implementation of the present invention, marketers can replace the challenge with queries to solicit brand feedback. For example FIG. 8 illustrates a display screen 800 with a request 810 where a series 805 of elements is introduced relating to the advertiser as well as their competitive marketplace. Some elements 806 may include a product or service from the advertisement itself, while other elements 807 may include intrinsic elements of the advertisement itself to gauge the user's interest in said advertisement. Elements 808 and 809 may include complementary or competitive products by the same advertiser or other competitors. The user makes their selection from the series of elements using box 815. Providing dynamic and potentially user-targeted brand feedback post-streaming of advertisements can provide valuable feedback to the advertiser on the quality of their advertisement, messaging, positioning and the competitive dynamics of their marketplace.

Embodiments described herein may be incorporated into various devices and systems including, but not limited to, various computing and/or consumer electronic devices/appliances, and communication systems.

It is to be understood that the disclosure teaches just a few illustrative examples and that many variations of the invention can easily be devised by those skilled in the art after reading this disclosure.

1. A method of increasing user engagement with advertising, for a user consuming streamed user-selected content, the method comprising:
selecting a sequence of previously produced advertisements, beginning with a first advertisement followed by a second advertisement, for the user;
for each of the advertisements in the selected sequence, generating a first challenge relating to that advertisement, the generation occurring subsequent to and independent of the production of that advertisement; and
at a break in streaming the selected content to a device through which the user is experiencing the user-selected content:
streaming the first advertisement to the device;
after the first advertisement ends, presenting the corresponding first challenge to the user on the device; and
responding to a correct answer provided by the user, within a first set time interval, to the first challenge by terminating the break and resuming streaming of the user-selected content to the device.

2. The method of claim 1 further comprising, if no correct answer is provided by the user to the first challenge within the first set time interval in the break:
streaming the second advertisement in the selected sequence of advertisements to the device;
presenting the generated first challenge corresponding to the second advertisements to the user; and
responding to a correct answer provided by the user, within a second set time interval, to the first challenge by terminating the break and resuming streaming of the user-selected content to the device.

3. The method of claim 1 further comprising:
for each of the advertisements, additionally generating an alternative challenge, different from the first challenge, relating to that advertisement, the additional generation occurring subsequent to and independent of the production of that advertisement; and
if, after streaming the first advertisement and presenting the corresponding first challenge, no correct answer is provided by the user to the first challenge within the first set time interval in the break:
presenting the alternative challenge relating to that advertisement to the user on the device; and
responding to a correct answer provided by the user, within a third set time interval, to the alternative challenge by terminating the break and resuming streaming of the user-selected content to the device.

4. The method of claim 1,
wherein the first advertisement comprises a narrative; and
wherein the first challenge presents two or more statements regarding the narrative, at least one of the statements being true, and asks the user to select a true statement from the presented two or more statements.

5. The method of claim 4, wherein generating a first challenge comprises using Artificial Intelligence technology (AI).

6. The method of claim 1,
wherein the first advertisement, as previously produced, intrinsically includes a perceptible element; and
wherein the first challenge asks the user to select the perceptible element from a series of presented elements, the series including the perceptible element and other elements that were not included in the first advertisement.

7. The method of claim 1,
wherein the first advertisement, as previously produced, intrinsically includes a perceptible element; and
wherein the first challenge asks the user to confirm or deny the presence of the perceptible element from a series of displayed elements, wherein the series may optionally include the perceptible element.

8. The method of claim 1,
wherein the first advertisement includes one or more streamed scenes; and
wherein the first challenge asks the user to select from a series of other scenes, not shown in the first advertisement, whichever of these other scenes is most similar to any one of the one or more streamed scenes.

9. The method of claim 7, wherein generating the challenge asking the user to select the scene comprises using Artificial Intelligence technology (AI).

10. The method of claim 1 additionally comprising, after the selection of a sequence of previously produced advertisements and before or during the presentation of one of the advertisements in the selected sequence:
introducing a perceptible element into a scene within that advertisement;
wherein the first challenge generated for that advertisement asks the user to select the introduced perceptible element from a series of displayed elements, the series including the introduced perceptible element and other elements that were not included in that advertisement.

11. The method of claim 1 additionally comprising, after the selection of a sequence of previously produced advertisements and before or during the presentation of one of the advertisements in the selected sequence:
introducing a perceptible element into a scene within that advertisement;
wherein the first challenge generated for that advertisement asks the user to confirm or deny the presence of the introduced perceptible element from a series of displayed elements, wherein the series may optionally include the perceptible element.

12. The method of claim 1, wherein at least one of an order in which the advertisements are arranged in the selected sequence, content of the selected advertisements selected, and content of the generated challenge is determined by characteristics of the user.

13. An apparatus for increasing user engagement with advertising, for a user consuming streamed user-selected content, the apparatus comprising:
one or more processors; and
logic encoded in one or more non-transitory media for execution by the one or more processors and when executed operable to:
select a sequence of previously produced advertisements, beginning with a first advertisement followed by a second advertisement, for the user;
for each of the advertisements in the selected sequence, generate a first challenge relating to that advertisement, the generation occurring subsequent to and independent of the production of that advertisement; and
at a break in streaming the selected content to a device through which the user is experiencing the user-selected content:
stream the first advertisement to the device;
after the first advertisement ends, present the corresponding first challenge to the user on the device; and
respond to a correct answer provided by the user, within a first set time interval, to the first challenge by terminating the break and resuming streaming of the user-selected content to the device.

14. The apparatus of claim 13, wherein the logic when executed is further operable to:
if no correct answer is provided by the user to any one of the corresponding questions within the first set time interval:
stream the second advertisement in the selected sequence of advertisements to the device;
present the generated first challenge corresponding to the second advertisements to the user; and
respond to a correct answer provided by the user, within a second set time interval, to the first challenge by terminating the break and resuming streaming of the user-selected content to the device.

15. The apparatus of claim 13, wherein the logic when executed is further operable to:
for each of the advertisements, additionally generate an alternative challenge, different from the first challenge, relating to that advertisement, the additional generation occurring subsequent to and independent of the production of that advertisement; and
if, after streaming the first advertisement and presenting the corresponding first challenge, no correct answer is provided by the user to the first challenge within the first set time interval in the break, to:
present the alternative challenge relating to that advertisement to the user on the device; and
respond to a correct answer provided by the user, within a third set time interval, to the alternative challenge by terminating the break and resuming streaming of the user-selected content to the device.

16. The apparatus of claim 13,
wherein the first advertisement comprises a narrative; and
wherein the first challenge presents two or more statements regarding the narrative, at least one of the statements being true, and asks the user to select a true statement from the presented two or more statements.

17. The apparatus of claim 13,
wherein the first advertisement, as previously produced, intrinsically includes a perceptible element; and
wherein the first challenge asks the user to select the perceptible element from a series of presented elements, the series including the perceptible element and other elements that were not included in the first advertisement.

18. The apparatus of claim 13,
wherein the first advertisement, as previously produced, intrinsically includes a perceptible element; and
wherein the first challenge asks the user to confirm or deny the presence of the perceptible element from a series of displayed elements, wherein the series may optionally include the perceptible element.

19. The apparatus of claim 13, wherein the logic is further operable, after the selection of a sequence of previously produced advertisements and before or during the presentation of one of the advertisements in the selected sequence, to:
introduce a perceptible element into a scene within that advertisement;
wherein the first challenge generated for that advertisement asks the user to select the introduced perceptible element from a series of displayed elements, the series including the introduced perceptible element and other elements that were not included in that advertisement.

20. The apparatus of claim 13, wherein the logic is further operable, after the selection of a sequence of previously produced advertisements and before or during the presentation of one of the advertisements in the selected sequence, to:
introduce a perceptible element into a scene within that advertisement;
wherein the first challenge generated for that advertisement asks the user to confirm or deny the presence of the introduced perceptible element from a series of displayed elements, wherein the series may optionally include the perceptible element.
